(19) United States
(12) Patent Application Publication
(10) Pub. No.: US 2022/0162487 A1
(43) Pub. Date: May 26, 2022

(54) COMPOSITIONS AND METHODS FOR REDUCING AIRBORNE PARTICULATE MATTER

(71) Applicant: WESTLAKE ROYAL ROOFING LLC, Houston, TX (US)

(72) Inventors: Hamed MARAGHECHI, San Antonio, TX (US); Matthew Yatco MENESES, San Antonio, TX (US); Amitabha KUMAR, San Antonio, TX (US); Russell L. HILL, San Antonio, TX (US)

(73) Assignee: WESTLAKE ROYAL ROOFING LLC, Houston, TX (US)

(21) Appl. No.: 17/441,306

(22) PCT Filed: Mar. 19, 2020
(86) PCT No.: PCT/US2020/023626

§ 371 Date: Sep. 21, 2021

Related U.S. Application Data
(60) Provisional application No. 62/822,619, filed on Mar. 22, 2019.

(51) Int. Cl. C09K 3/22

(52) U.S. Cl. CPC C09K 3/22

(57) ABSTRACT

Dust suppression agents and methods of use, e.g., to reduce operator exposure to particulate matter released during machining of a material, are described. The method may include providing a retained dust suppression agent proximate to a surface of the material and machining the material at the surface with a tool having a mechanized motion. The mechanized motion of the tool may release at least a portion of the retained dust suppression agent to reduce operator exposure to respirable particulate matter from the material as compared to machining the material at the surface absent the retained dust suppression agent.

### CROSS-REFERENCE TO RELATED APPLICATIONS

This application claims priority to U.S. Provisional Application No. 62/822,619, filed on Mar. 22, 2019, which is incorporated by reference herein in its entirety.

### TECHNICAL FIELD

The present disclosure generally relates to compositions and methods useful during machining of materials. More specifically, the compositions and methods herein may allow for reduced exposure to respirable or otherwise airborne particulate matter.

### BACKGROUND

Machining of many types of materials releases dust. The U.S. Occupational Safety and Health Administration (OSHA) provides standards defined in 29 CFR 1910.1053 for general industry and maritime, and 29 CFR 1926.1153 for construction, regarding exposure to respirable particulate matter. Under these standards, employers must ensure that exposures to respirable crystalline silica remain below the Permissible Exposure Limit (PEL) of 50 μg/m³ as an 8-hour time weighted average. Thus, exposures can fluctuate over the course of any 8-hour work shift, but the average exposure to respirable crystalline silica must be below 50 μg/m³. The standard includes an action level threshold of 25 μg/m³ [§§ 1910.1053(d)(3) and 1926.1153(d)(2)(iii)]. That is, exposures greater than 25 μg/m³ over the course of an 8-hour time weighted average require employers to take measures to reduce the exposure and retest within certain time to ensure that the respirable crystalline silica exposure is below the action level. Exposures determined to be less than the 25 μg/m³ Action Level exempt an employer from further obligations under the standard if an initial or two consecutive determinations are less than the 25 μg/m³.

### SUMMARY

The present disclosure includes dust suppression agents and methods of machining a material using such dust suppression agents. For example, the present disclosure includes a method of machining a material, comprising providing a dust suppression agent, e.g., a retained dust suppression agent, proximate to a surface of the material; and machining the material at the surface with a tool having a mechanized motion; wherein the mechanized motion of the tool releases at least a portion of the retained dust suppression agent to reduce operator exposure to respirable particulate matter from the material as compared to machining the material at the surface absent the retained dust suppression agent. The retained dust suppression agent may be in the form of a liquid, a gel, a paste, a foam, a pad, a pouch, a sponge, or a tape. Further, for example, the retained dust suppression agent may comprise a polymer, a textile, or both, such as, e.g., a polymer sponge, polyurethane, sodium polyacrylate, fabric, cellulose, or a combination thereof.

According to some examples herein, the retained dust suppression agent is applied to the surface of the material with an adhesive. The retained dust suppression agent may comprise an absorbent material and water. In at least one example, the retained dust suppression agent is saturated with water. The method may further comprise adding moisture to the retained dust suppression agent after providing the retained dust suppression agent proximate to the surface of the material and/or removing at least a portion of the retained dust suppression agent from the material after machining. The material may be a building material, e.g., comprising concrete.

The present disclosure also includes a method of machining a material, comprising providing a dust suppression agent, e.g., a retained dust suppression agent, proximate to a surface of the material, wherein the retained dust suppression agent comprises an absorbent polymer, a textile, or both; and machining the material with a blade, bit, or knife by a dry machining process; wherein the material is a building material, and the dry machining process releases at least a portion of the retained dust suppression agent to inhibit release of respirable particulate matter from the building material during the dry machining process. For example, the retained dust suppression agent is in the form of a liquid, a gel, a pad, a pouch, a sponge, or a tape. Additionally or alternatively, the building material may comprise silica. For example, the building material may be a tile, a brick, or a board. The retained dust suppression agent may further comprise water or non-aqueous liquid. The retained dust suppression agent may be applied to the surface of the material immediately before or during the dry machining process. Optionally, the retained dust suppression agent has a thickness of about 1 mm to about 5 mm, e.g., about 3 mm to about 4 mm.

The present disclosure further includes a method of machining a material, comprising providing a dust suppression agent, e.g., a retained dust suppression agent, proximate to a surface of the material, wherein the retained dust suppression agent is in the form of a liquid, a gel, a paste, a foam, a pad, a pouch, a sponge, or a tape; and machining the material by a dry machining process; wherein the material comprises concrete, and the dry machining process releases at least a portion of the retained dust suppression agent to inhibit release of respirable particulate matter from the concrete during the dry machining process. In at least some examples herein, the concrete comprises silica. The presence of the retained dust suppression agent may reduce operator exposure to respirable particulate matter from the material as compared to machining the material absent the retained dust suppression agent.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIGS. 1A and 1B show an exemplary pouch, according to some aspects of the present disclosure.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ±5% of a specified amount or value. All ranges are understood to include endpoints, e.g., 1 mm to 5 mm (or between 1 mm and 5 mm) includes 1 mm, 5 mm, and all values between.

The present disclosure includes dust suppression agents for inhibiting release of and/or reducing exposure of an operator to particulate matter, including respirable particulate matter, from a material during a machining process. As used herein, the term “dust” is understood to include all types of inorganic materials, organic materials, and mixtures thereof, in the form of particulate material having the capability of becoming airborne (e.g., respirable) and inhaled by machinery operators and/or bystanders. The dust suppression agents and methods of use herein may reduce operator exposure to respirable particulate matter released from the material during machining as compared to machining the material in the absence of the dust suppression agent.

The dust suppression agents may be in the form of a liquid, a gel, a semi-solid, a paste, a foam, a pad, a pouch, a sponge, a tape, or a combination thereof. The dust suppression agent may be retained, that is, provided in a form suitable for localized delivery to, at, or proximate a surface. For example, the retained dust suppression agent may comprise a pad or pouch that optionally contains a liquid, gel, or paste. Further, for example, the retained dust suppression agent may be in the form of a spreadable paste, gel, or foam to be applied to the surface, or in the form of a tape that may be adhered to a surface with or without an adhesive. The dust suppression agent may include moisture, e.g., water, another liquid a mixture of liquids that may be aqueous or non-aqueous, a gel, a paste, a foam, or any other fluid or fluid-like material.

Without intending to be bound by theory, it is believed that using a dust suppression agent may help to entrain fine particulate matter released from a material during a machining process. For example, water or other moisture present in the dust suppression agent may at least partially wet particulate matter released from the material, such as a building material, and prevent the particulate matter from becoming airborne.

The dust suppression agents herein may be used with any suitable materials, which may be inorganic, organic, or a combination thereof. Exemplary materials include, but not limited to, concrete, cement, natural stone, rock, marble, onyx, granite, slate, ceramic, terra cotta, travertine, limestone, quartzite, sandstone, shale, brick, mortar, asphalt, drywall, fiber cement, plaster, gypsum board, stucco, clay, terrazzo, polymers, and polymer composites. Examples of polymers and polymer composites contemplated herein include, e.g., polyurethane, polyurea, and/or polyisocyanurate, which may include one or more fillers, such as fly ash, amorphous carbon (e.g., carbon black), limestone, calcium carbonate, silica, and/or alumina, among other particulate fillers. Machining of these and other materials can release various species such as silica that may present health concerns, particularly when they become airborne. The dust suppression agents and methods of use thereof may provide for reduced respirable particulate matter, including, e.g., respirable crystalline silica, when manipulated or otherwise processed, such as by a machining process.

All or a portion of the dust suppression agent may be absorbent. For example, the dust suppression agent may comprise an absorbent and/or wicking material. Further, according to some aspects herein, all or a portion of the dust suppression agent may be water soluble.

According to some aspects of the present disclosure, the dust suppression agent comprises a polymer, textile, polysaccharides and other organic compounds, and/or cellulosic material. Exemplary polymers include, but are not limited to, polyurethane, polyethylene, polypropylene, polyester, superabsorbent polymers such as sodium polyacrylate, and polyacrylamide. Exemplary textiles include, but are not limited to, fabric, cotton, flax, fiber, linen, and lint. Exemplary cellulosic materials include, but are not limited to, cellulose (e.g., cellulose mat), cross-linked carboxymethylcellulose, and paper. Exemplary polysaccharides and other organic compounds include, but are not limited to, agar agar (seaweed), simple and complex carbohydrates such as starch or starch complexes, gelatin, collagen, gums such as tragacanth and gum Arabic, waxes, and resins.

As mentioned above, the dust suppression agent may be absorbent. According to some aspects of the present disclosure, the dust suppression agent comprises at least 5% moisture, e.g., from 5 wt % to 95 wt % or more moisture. The moisture content of the dust suppression agent may be calculated by weighing the dust suppression agent before and after drying:

$$\frac{{W}_{wet} - {W}_{dry}}{{W}_{wet}} \times 100 \% \qquad Eq . 1$$

wherein W_{wet} is the weight of the dust suppression agent in a wetted state and W_{dry} is the weight of the dust suppression agent after driving off moisture in an oven or desiccator, as measured at room temperature and pressure (20-25° C., 1 atm.) and an average relative humidity of 30-60%. For example, the dust suppression agent may have a moisture content of 10 wt % to 80 wt %, 50 wt % to 90 wt %, 25 wt % to 75 wt %, 30 wt % to 50 wt %, 55 wt % to 75 wt %, 45 wt % to 65 wt %, or 70 wt % to 95 wt %. Further, for example, the dust suppression agent may be supersaturated.

The moisture may comprise, consist of, or consist essentially of water, an aqueous solution, or a non-aqueous liquid or solution. For example, the moisture may comprise one or more alcohols, oils (e.g., a greasy mixture), and waxes with a high boiling point. The liquid may be non-hazardous, environmentally friendly, and/or non-toxic. According to some aspects, the dust suppression agent is provided in a dry form and moisture (e.g., water or other liquid) is added to the dust suppression agent immediately before or during a machining process. The dust suppression agents herein optionally may include one or more compounds or materials that prevent the growth of biological media, such as mold or algae. Such biocide and microbicide compounds may include isothiazolinones such as methylisothiazolinone and chloromethylisothazolinone, and alkaline copper quaternary, among other examples.

In some examples, the dust suppression agent is applied in the form of a liquid, a paste, a gel, a foam, or a combination thereof. The dust suppression agent may be provided in a container or other suitable device that allows for discharging the dust suppression agent at or proximate the surface of the material to be machined, such that at least a portion of the dust suppression agent is available to interact with particulate material released during the machining process. In some examples, the dust suppression agent may be discharged proximate to the machining device used for cutting a material. Containers useful for holding dust suppression agents may include, for example, spray bottles with or without use of a propellant, tubes, syringes, and squeeze bottles, among other examples. The dust suppression agent may be discharged manually or automatically, e.g., via an electronic mechanism. In some cases, the dust suppression agent may be applied to the surface of a material with an applicator, such as a brush, a sponge, or a dropper, among other types of applicators. Such discharge may be made to the machining device (e.g., proximate a knife, bit, or blade used for cutting) and/or to the surface of the material being cut. The dust suppression agent may be applied intermittently during machining, continuously during machining, and/or prior to machining. The dust suppression agent may be or comprise, for example, a viscous aqueous material and/or non-aqueous material. After machining, the dust suppression agent optionally may be removed from the surface, e.g., by washing with water or other fluid or material, and/or by wiping or brushing the dust suppression agent from the surface.

In some examples herein, the dust suppression agent is in the form of a pad, e.g., having a sheet-like shape defined by one or more layers of material. For example, the pad may include one, two, or three or more layers of a polymer, textile, or cellulosic material, e.g., up to 10 layers, 20 layers, or 25 or more layers. Such pads, when applied with sufficient thickness and sufficient moisture content (e.g., water content) may be capable of suppressing airborne dust and, in some cases, simultaneously trapping the dust for disposal. The pad may be absorbent, e.g., having a wicking or otherwise porous structure that allows for retention of moisture. In at least one example, the retained dust suppression agent comprises a pad having a thickness of 0.5 mm to 5 mm, such as 3 mm to 4 mm. The pad may comprise, for example, polyurethane, polyethylene, polypropylene, polyester, cellulose, carboxymethylcellulose, cotton, flax, fiber, or a combination thereof.

The dust suppression agent may be in the form of a pouch, e.g., defining a cavity that contains a liquid, a gel, a paste, a foam, a pad, a sponge, a semi-solid, or a combination thereof. In at least one example, the dust suppression agent comprises a textile or polymer formed into a pouch, the pouch defining a cavity configured to hold a fluid such as water or other liquid, or to hold an absorbent material capable of absorbing a fluid such as water or other liquid. The pouch may contain liquids of an aqueous or non-aqueous nature. The material(s) forming the pouch may be at least partially absorbent. In some examples, the pouch may be configured to retain moisture inside the pouch and prevent or at least inhibit loss of moisture to surroundings. In certain embodiments, the pouch may be partially or completely filled with one or more absorbent pads, cellular foams, and/or viscous aqueous or non-aqueous materials. Any of the materials mentioned above in connection to a pad may be used to form the pouch and/or contained within the cavity of the pouch.

The pouch may include one or more wet layers and/or dry layers of absorbent or sponge-like material or combination of materials. In the case of dry layers, for example, the pouch may allow for the introduction of water or other moisture prior to application to a surface. For example, the pouch may include a single port or multiple ports for receiving liquid. Multiple ports may be provided as openings, channels, pores, or passageways in the pouch. In the case of a pouch with a pre-wetted material, the pouch may be configured to retain the moisture therein. For example, the pouch may be sealable, e.g., having sufficient capacity to be sealed so as to contain the moisture without substantial evaporation or other loss to surroundings.

Optionally the pouch may include one or more markings to designate an intended machining area or path. For example, the markings on the pouch may be aligned with one or more markings on the surface of the material and/or features of the material such as an edge, a grout line, etc.

According to some examples herein, the dust suppression agent may be applied directly to the surface of the material to be machined. For example, a pad or pouch may be disposed on the surface with or without an adhesive. In some cases, the weight of the dust suppression agent may be sufficient to keep the dust suppression agent in place during machining. Additionally or alternatively, the dust suppression agent may be or become at least partially sticky or tacky (e.g., upon the addition of moisture) so as to adhere to the surface.

In some cases, an additional agent may be used to maintain the position of the dust suppression agent relative to the surface of the material to be cut or otherwise machined. For example, an adhesive such as a glue may be applied to dust suppression agent in the form of a pad or pouch to the surface. The adhesive may be water soluble. Exemplary adhesives include, but are not limited to, starches and water-soluble polymers such as polyvinyl alcohol. Thus, a dust suppression agent in the form of a pad or pouch may be applied to a material surface using an adhesive. In at least some examples herein, however, the dust suppression agent does not include an adhesive.

In certain embodiments, the pouch or pad may be adhered to the surface or surfaces in a manner so as to retain the pouch after machining. In other examples, the pad or pouch may be adhered to the surface(s) so as to permit removal of the pouch after cutting. After machining, the pad or pouch may be removed from the surface together with the adhesive, if present. For example, in the case of a water-soluble adhesive, remnants of the dust suppression agent and adhesive may be removed by washing with water or other liquid or material.

The dimensions of the dust suppression agent may be selected based on the type and size of material being machined, the type of dust suppression agent, and/or the location and/or size of the cut to be made in the material by a machining process. The retained dust suppression agent may have any suitable dimensions of length, width, and thickness, wherein the length and width refer to dimensions along the x-axis and y-axis, respectively, and thickness refers to the dimension along the z-axis. In some cases, the retained dust suppression agent may have dimensions complementary to the dimensions of the material to be machined and/or a portion of the material to be cut by a machining process.

For example, the dust suppression agent may have a length of at least 0.1% to 100% (e.g., 0.1% to 5%, 1% to 10%, 25% to 75%, or 50% to 100%) the length of the material and/or a width of at least 0.1% to 100% (e.g., 0.1% to 5%, 1% to 10%, 25% to 75%, or 50% to 100%) the width of the material. The thickness of the retained dust suppression agent may be uniform or may vary. In some aspects of the present disclosure, the thickness of the retained dust suppression agent is 0.1 mm to 10 mm, such as 0.5 mm to 5 mm, 1 mm to 5 mm, 2 mm to 7 mm, 3 mm to 4 mm, 1 mm to 3 mm, 0.5 mm to 2.5 mm, 0.1 mm to 0. 5 mm, or 0.1 mm to 1 mm.

The dust suppression agent may be pre-formed into the desired dimensions, may be cut or otherwise shaped into the desired dimensions (e.g., from a larger piece or portion of dust suppression agent), or may be applied to the surface of the material so as to have the desired dimensions (e.g., in case of a shapeable formulation, such as a liquid, paste, gel, or foam). In one non-limiting example, the material to be machined is a tile having dimensions of 6-18 in. by 6-18 in. (length by width), and the retained dust suppression agent has dimensions of 0.1-18 in. by 0.1-18 in (length by width). For example, if the tile is to be cut along a length of 12 in., the retained dust suppression agent may have a length of at least 6 in. (at least 50% the length of the tile) and a width of at least 0.5 in. (at least about 8% the width of the tile). In another non-limiting example, the material to be machined is a concrete block having dimensions of 12-18 ft. by 1-2 ft. (length by width), and the retained dust suppression agent has dimensions of 1 in. to 12 ft. by 0.1 in. to 1 ft. (length by width). These dimensions are exemplary only, and the skilled artisan may select suitable dimensions according to the size and type of material to be machined, and the amount and type of dust suppression agent to be used.

In at least one example, the dust suppression agent comprises a pouch that defines a cavity, the cavity containing moisture in the form of a liquid, a gel, a paste, a foam, a pad, a sponge, a semi-solid, or a combination thereof. The pouch may be sealable, e.g., via an adhesive, stitches, clips, staples, or other attachment mechanism. The pouch may include an adhesive on an exterior surface of the pouch, e.g., a top or bottom surface, in order to attach the pouch to the surface of the material to be machined within the intended machining area and/or along the intended machining path. For example, the pouch may be attached to the surface of a tile along an intended cut line. Optionally the pouch may include one or more markings, e.g., which may be aligned with one or more markings on the surface of the material to designate an intended machining area or path. The walls of the pouch defining the cavity may comprise, for example, fabric, cotton, flax, fiber, linen, or lint, cellulose mat, cross-linked carboxymethylcellulose, paper, polyurethane, polyethylene, polypropylene, polyester, or a combination thereof. The cavity of the pouch may contain, for example, water, alcohols, oils, waxes with a high boiling point, superabsorbent polymers such as sodium polyacrylate and/or polyacrylamide, polysaccharides and/or other organic compounds such as agar agar, simple or complex carbohydrates, e.g., starch or starch complexes, gelatin, collagen, gums, e.g., tragacanth or gum Arabic, waxes, resins, or a combination thereof.

In at least one example, the dust suppression agent comprises a pad that is at least partially absorbent, the pad containing moisture in the form of water, an aqueous solution, or a low-volatile non-aqueous liquid. The pad optionally may be to the desired dimensions of the material to be machined, e.g., such that the pad may be attached to the surface of the material within the intended machining area and/or along the intended machining path. The pad may comprise a textile, such as fabric, cotton, linen, or lint; a cellulosic material such as cellulose mat, cross-linked carboxymethylcellulose, or paper; a polymer such as polyurethane, polyethylene, polypropylene, or polyester; or a combination thereof.

In at least one example, the dust suppression agent comprises a liquid, a gel, a paste, or a foam, which may be housed within a container such as a spray bottle, a tube, a syringe, or a squeeze bottle. For example, the dust suppression agent may comprise an aqueous solution, or a low-volatile non-aqueous liquid, optionally combined with one or more other materials or compounds such as a polysaccharide, starch, starch complex, gelatin, collagen, tragacanth, gum Arabic, wax, resin, sodium polyacrylate, polyacrylamide, or a combination thereof.

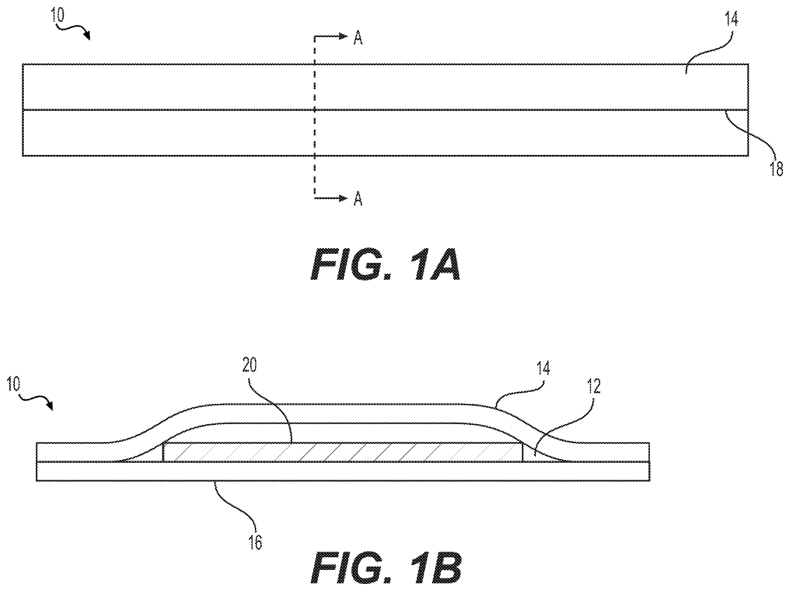

FIGS. 1A and 1B show an exemplary pouch 10, wherein FIG. 1A shows a top view and FIG. 1B shows a cross-sectional view along line A-A in FIG. 1A. The pouch 10 includes a top surface 14 and bottom surface 16 each having a generally rectangular shape (although other shapes could be used). The pouch 10 defines a cavity 12 between the top surface 14 and the bottom surface 16 for receiving and/or retaining a dust suppression agent. For example, FIG. 1B shows a pad 20 disposed within the cavity 12. The pad 20 may comprise, for example, an absorbent material. The top surface 14 includes an intended cut line 18, e.g., which may be provided by any appropriate markings or materials. In use, an operator may apply the pouch 10 to the surface of a material to be cut, such that the intended cut line 18 of the pouch 10 is aligned and oriented so as to guide a machining tool along the intended machining path. Optionally, the bottom surface 16 of the pouch 10 may include an adhesive, or an adhesive may be applied to the bottom surface 16 of the pouch 10 and/or the surface of the material to be cut so as to attach the pouch 10 to the material. Thus, for example, after cutting, the intended cut line 18 may overlay an edge or border of the cut material. Optionally, the remainder of the pouch 10 may be removed from the material after cutting.

The dust suppression agents herein may be used to facilitate machining of any suitable materials, including building materials and products such as tiles (roof tiles, floor tiles, bathroom tiles, kitchen tiles, pool tiles, siding tiles, etc.), countertops, driveways, sidewalks, bricks, masonry blocks, stones, cladding, and other materials and products. As mentioned above, the materials may comprise concrete, cement, natural stone, rock, marble, onyx, granite, slate, ceramic, terra cotta, travertine, limestone, quartzite, sandstone, shale, brick, mortar, asphalt, drywall, fiber cement, plaster, gypsum board, stucco, clay, and terrazzo, among other examples. According to some aspects of the present disclosure, machining of the material may be performed before or after mounting the material to a support. When the composition is a roof tile, for example, the support may be sheathing, a batten, or other material on the roof of a building suitable for securing tiles thereto. For example, the support may comprise wood, plastic, or metal.

Any of the dust suppression agents herein may be applied during manufacture of a building product or other material, and/or may be applied to the material on-site during machining. In the case of a building product such as a tile, for example, the product may be supplied in combination with one or more dust suppression agents suitable for that product. For example, a pad or pouch having dimensions compatible with the tile may be used and/or one or more tiles in a collection of tiles may be provided with one or more dust suppression agents adhered to the tile surface. An operator thus may select the tiles equipped with dust suppression agents as the products to be cut on-site to suit a custom size.

The dust suppression agents and methods of use thereof may provide for reduced respirable particulate matter, including, e.g., respirable crystalline silica, when manipulated or otherwise processed, e.g., by machining. The machining may utilize a tool having a mechanized motion, e.g., a blade (such as a saw blade), bit, or knife. As used herein, machining refers to any type of process performed by a machining that removes at least a portion of the material (including sawing, cutting, turning, grinding, boring, drilling, planing, shaping, reaming, tapping, broaching, sanding, etc.), other than chiseling and chipping. Dry machining refers to a machining process performed under dry conditions. For example, dry machining does not include the continuous addition of a liquid proximate the cut, e.g., as in the case of a wet cutting saw. An example of a saw used for dry machining of tiles is a concrete saw equipped with a diamond saw blade having a blade thickness of about 0.135 inch.

In at least one example, machining the material by a dry machining process results in exposures under a Permissible Exposure Limit (PEL) of 50 micrograms of respirable crystalline silica per cubic meter of air (50 μg/m³) as an 8-hour time-weighted average as defined by 29 CFR 1926.1153(b). In at least one example, dry machining of the material results in a less than action level exposure to respirable crystalline silica per cubic meter of air (25 μg/m³) as an 8-hour time-weighted average, as defined by 29 CFR 1926.1153(b). The compositions and methods herein also may comply with the applicable OSHA regulations when manipulated by equipment (saws, grinders, etc.) designed to minimize respirable crystalline silica with dust collection devices, vacuum dust traps, baghouses, fluid, etc. For example, certain machining features such as the type of saw, blade design, frequency of teeth, kerf, speed (revolutions per minute), and the like, may be selected to further reduce the amount of dust released. Respirable crystalline silica may be measured according to NIOSH 7500 and OSHA ID-142.

Different types and forms of dust suppression agents may be selected to suit the types and forms of the materials to be cut. Some materials may be more prone to release particulate matter during a machining process. For example, materials that contain silica sand or other types of silica can release significant amounts of particulate matter, whereas other materials comprising polymers or polymer fillers may generally release less particulate matter. A dust suppression agent with a relatively low moisture content (e.g., 10% or less) and/or low adhesion characteristics may be suitable for polymer-containing materials where the dust suppression agent need not entrain high amounts of particles. In the case of materials containing silica, dust suppression agents with high moisture content and/or greater adhesion may be more suitable. For example, a dust suppression agent with at least 30 wt % moisture content and/or a dust suppression agent with high localized adhesion to the surface, such as a tape, may prevent silica and/or other particulate material from being released into the air during machining.

In an exemplary process, two samples of a material are prepared with the same chemical composition and dimensions. The first sample is machined by being cut with a circular saw without any dust collection system (e.g., dry saw without vacuum extractor). Dust generated during cutting is visibly observed and/or collected around the cutting device. The second sample is machined by being cut with a circular saw in the same manner as the first sample, but in the presence of a dust suppression agent. Dust generated during cutting of the second sample is also visibly observed and/or collected around the cutting device. Comparison of the amount of dust generated during cutting of the first sample and the second sample (e.g., by visual observation and/or quantitative measurements) may be used to assess efficacy of the dust suppressant agent. The dust suppression agent may be, e.g., a pad, pouch, tape, liquid, gel, paste, foam, or sponge that includes moisture, the dust suppression agent covering the second sample at least along the cut line.

It is intended that the specification and figures be considered as exemplary only, with a true scope and spirit of the present disclosure being indicated by the following claims.

What is claimed is:

1. A method of machining a material, comprising:
providing a retained dust suppression agent proximate to a surface of the material; and
machining the material at the surface with a tool having a mechanized motion;
wherein the mechanized motion of the tool releases at least a portion of the retained dust suppression agent to reduce operator exposure to respirable particulate matter from the material as compared to machining the material at the surface absent the retained dust suppression agent.

2. The method of claim 1, wherein the retained dust suppression agent comprises a polymer, a textile, or both.

3. The method of claim 1, wherein the retained dust suppression agent comprises polyurethane, sodium polyacrylate, fabric, cellulose, or a combination thereof.

4. The method of claim 1, wherein the retained dust suppression agent comprises a polymer sponge.

5. The method of claim 1, wherein the retained dust suppression agent is in the form of a liquid, a gel, a paste, a foam, a pad, a pouch, a sponge, or a tape.

6. The method of claim 1, wherein the retained dust suppression agent is applied to the surface of the material with an adhesive.

7. The method of claim 1, wherein the retained dust suppression agent comprises an absorbent material and water.

8. The method of claim 7, wherein the retained dust suppression agent is saturated with water.

9. The method of claim 1, further comprising adding moisture to the retained dust suppression agent after providing the retained dust suppression agent proximate to the surface of the material.

10. The method of claim 1, wherein the material is a building material comprising concrete.

11. The method of claim 1, further comprising removing at least a portion of the retained dust suppression agent from the material after machining.

12. A method of machining a material, comprising:
providing a retained dust suppression agent proximate to a surface of the material, wherein the retained dust suppression agent comprises an absorbent polymer, a textile, or both; and
machining the material with a blade, bit, or knife by a dry machining process;
wherein the material is a building material, and the dry machining process releases at least a portion of the retained dust suppression agent to inhibit release of respirable particulate matter from the building material during the dry machining process.

13. The method of claim 12, wherein the retained dust suppression agent is in the form of a liquid, a gel, a pad, a pouch, a sponge, or a tape.

14. The method of claim 12, wherein the building material comprises silica.

15. The method of claim 12, wherein the building material is a tile, a brick, or a board.

16. The method of claim 12, wherein the retained dust suppression agent further comprises water or non-aqueous liquid.

17. The method of claim 12, wherein the retained dust suppression agent is applied to the surface of the material immediately before or during the dry machining process.

18. The method of claim 12, wherein a thickness of the retained dust suppression agent is 1 mm to 5 mm.

19. A method of machining a material, comprising:
providing a retained dust suppression agent proximate to a surface of the material, wherein the retained dust suppression agent is in the form of a liquid, a gel, a paste, a foam, a pad, a pouch, a sponge, or a tape; and
machining the material by a dry machining process;
wherein the material comprises concrete, and the dry machining process releases at least a portion of the retained dust suppression agent to inhibit release of respirable particulate matter from the concrete during the dry machining process.

20. The method of claim 19, wherein the concrete comprises silica.
